(19) United States
(12) Patent Application Publication
(10) Pub. No.: US 2017/0242554 A1
(43) Pub. Date: Aug. 24, 2017

(54) METHOD AND APPARATUS FOR PROVIDING SUMMARY INFORMATION OF A VIDEO

(71) Applicant: SAMSUNG ELECTRONICS CO., LTD., Suwon-si (KR)

(72) Inventors: Kiran NANJUNDA IYER, Bangalore (IN); Viswanath GOPALAKRISHNAN, Bangalore (IN); Smitkumar Narotambhai MARVANIYA, Bangalore (IN); Damoder MOGILIPAKA, Bangalore (IN)

(73) Assignee: SAMSUNG ELECTRONICS CO., LTD., Suwon-si (KR)

(21) Appl. No.: 15/251,088

(22) Filed: Aug. 30, 2016

(30) Foreign Application Priority Data
Feb. 19, 2016 (IN) 1452/CHE/2015
Jul. 4, 2016 (KR) 10-2016-0084270

(51) Int. Cl. G06F 3/0482; G06F 17/30; G06F 3/0484

(52) U.S. Cl. CPC G06F 3/0482; G06F 3/0484; G06F 17/30843

(57) ABSTRACT

A method of providing a summary of a video in an electronic device includes determining first summary frames from among a plurality of frames of the video, based on a preset criterion; generating a plurality of pieces of first summary information corresponding to the first summary frames; and displaying at least one of the first summary frames and the plurality of pieces of first summary information, together with at least one frame of the video.

### CROSS-REFERENCE TO RELATED PATENT APPLICATIONS

This application claims priority from Korean Patent Application No. 10-2016-0084270, filed on Jul. 4, 2016 in the Korean Intellectual Property Office, and Indian Patent Application No. 1452/CHE/2015, filed on Feb. 19, 2016 in the Indian Intellectual Property Office, the disclosures of which are incorporated herein in their entireties by reference.

### BACKGROUND

### 1. Field

Methods and apparatuses consistent with exemplary embodiments relate to summarizing a video and providing summary information of the video.

### 2. Description of the Related Art

With developments in multimedia technology and/or network technology, a user is able to generate a video by using a terminal device or receive a video from other terminal devices or a server (e.g., a service server) and utilize the received video.

When the number of videos that may be used by a user increases, the user may have difficulty in effectively selecting a video that the user wants to utilize. Accordingly, a technique of summarizing contents of the video and providing a summary of the video has been developed. However, in a related art technique, the summary of the video is merely a combination of some of existing videos (or images), and thus it is difficult for users to easily and confidently identify the contents of the video. Therefore, there is a need for a technique that provides effective summary information of videos.

### SUMMARY

One or more exemplary embodiments provide methods and apparatuses for summarizing a video and providing summary information of the video.

According to an aspect of an exemplary embodiment, there is provided a method of providing a summary of a video in an electronic device, the method including: determining first summary frames from among a plurality of frames of the video, based on a preset criterion; generating a plurality of pieces of first summary information corresponding to the first summary frames; and displaying at least one of the first summary frames and the plurality of pieces of first summary information, together with at least one frame of the video.

According to another aspect of an exemplary embodiment, there is provided an electronic device including: a display; and a processor configured to determine first summary frames from among a plurality of frames of the video, based on a preset criterion, and configured to generate a plurality of pieces of first summary information corresponding to the first summary frames. The processor may control the display to display at least one of the first summary frames and the plurality of pieces, together with at least one frame of the video.

According to still another aspect of an exemplary embodiment, there is provided an electronic device including: a memory; a processor; an input unit configured to receive a user input to select a first location and a second location of a video; and a display. The processor may obtain first summary information corresponding to at least one of first frames included between the first location and the second location, obtain at least one piece of second summary information corresponding to second frames of the video, the second frames excluding the first frames, and search for second summary information that matches with the first summary information from among the at least one piece of second summary information, and the display may display a partial video, of the video, corresponding to the searched second summary information.

According to still another aspect of an exemplary embodiment, there is provided a method of displaying a video on an electronic device, the method including: receiving a user input to select a first location and a second location of the video; obtaining first summary information corresponding to at least one of first frames included between the first location and the second location; obtaining at least one piece of second summary information corresponding to second frames of the video, the second frames excluding the first frames; searching for second summary information that matches with the first summary information, from the at least one piece of second summary information; and displaying a partial video, of the video, corresponding to the searched second summary information.

### BRIEF DESCRIPTION OF THE DRAWINGS

The above and/or other aspects will be more apparent by describing certain example embodiments with reference to the accompanying drawings, in which:

FIG. 1 illustrates a block diagram of user equipment (UE) that performs video summarization according to an exemplary embodiment;

FIG. 2 is a block diagram illustrating components of a UE, according to an exemplary embodiment;

FIG. 3 is a flowchart of a method of generating first summary frames by using key frames, according to an exemplary embodiment;

FIG. 4 is a flowchart of a method of processing first summary frames based on video navigation by using a UE, according to an exemplary embodiment;

FIG. 5 is a flowchart of a method of processing first summary frames based on an action summary search by using a UE, according to an exemplary embodiment;

FIG. 6 is a flowchart of a method of utilizing first summary frames, according to an exemplary embodiment;

FIG. 7 is a flowchart of a method of utilizing first summary frames to enhance a storage space, according to an exemplary embodiment;

FIG. 8 is a schematic view for explaining providing summary frames of an input video of an electronic device, according to an exemplary embodiment;

FIG. 9 is a flowchart of a method of generating summary information of summary frames, according to an exemplary embodiment;

FIG. 10 is a flowchart of a method of displaying a video from a selected first summary frame, according to an exemplary embodiment;

FIG. 11 illustrates an example of displaying a video from a selected first summary frame, according to an exemplary embodiment;

FIG. 12 is a flowchart of a video searching method according to an exemplary embodiment;

FIG. 13 is a flowchart of a method of searching for a video that matches with a reproduction section of a video, according to an exemplary embodiment;

FIG. 14 illustrates an example of selecting a partial area of a first summary frame, according to an exemplary embodiment;

FIG. 15 is a flowchart of a method of generating a master summary of a plurality of videos, according to an exemplary embodiment;

FIG. 16 is a schematic view for explaining a method of generating a master summary of a plurality of videos, according to an exemplary embodiment;

FIG. 17 illustrates an example of a method of displaying a video from a reproduction location of a selected summary frame, according to an exemplary embodiment;

FIG. 18 is a flowchart of a method of storing a portion of a video, according to an exemplary embodiment;

FIG. 19 illustrates an example of selecting a method of storing a video, according to an exemplary embodiment; and

FIG. 20 is a block diagram of an electronic device according to an exemplary embodiment.

FIG. 21 is a flowchart of a method of displaying a video in an electronic device, according to an exemplary embodiment.

### DETAILED DESCRIPTION

Certain exemplary embodiments are described in greater detail below with reference to the accompanying drawings.

In the following description, like drawing reference numerals are used for like elements, even in different drawings. The matters defined in the description, such as detailed construction and elements, are provided to assist in a comprehensive understanding of the exemplary embodiments. However, it is apparent that the exemplary embodiments can be practiced without those specifically defined matters. Also, well-known functions or constructions are not described in detail since they would obscure the description with unnecessary detail.

Throughout the specification, when an element is referred to as being “connected” or “coupled” to another element, it can be directly connected or coupled to the other element, or can be electrically connected or coupled to the other element with intervening elements interposed therebetween. In addition, the terms “comprises” and/or “comprising” or “includes” and/or “including” when used in this specification, specify the presence of stated elements, but do not preclude the presence or addition of one or more other elements.

In the present specification, the term ‘key frame(s)’ refers to an image(s) that appears in a video at regular time intervals, and the term ‘summary frame(s)’ refers to a frame determined as having relatively large change in an image from among the key frames. The summary frame(s) may include the key frame(s).

Further, displaying a video on an electronic device may include a reproducing state (e.g., a video image is being reproduced) or a hold state (e.g., a still image is displayed).

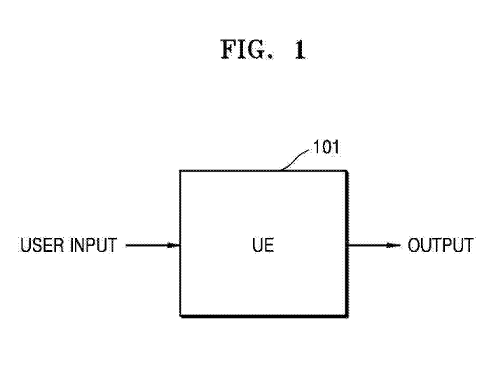

FIG. 1 illustrates a block diagram of user equipment (UE) that performs video summarization according to an exemplary embodiment.

The UE 101 may be any electronic device that can store data in at least one format. The UE 101 may include at least one component to capture and store data in the at least one format. The UE 101 may store data in a local memory, a cloud based on a storage space, or both. The UE 101 may further include at least one component to display media content to a user. The UE 101 may support at least one option to allow a user to interact with the UE 101, to manage the data. Examples of the UE 101 may include, but not limited to, a smartphone, a tablet computer, a personal digital assistant (PDA), and the like.

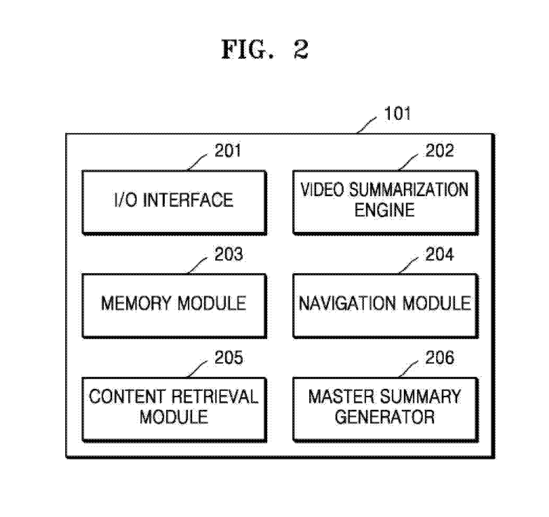

FIG. 2 is a block diagram illustrating components of the UE 101, according to an exemplary embodiment.

The UE 101 includes an input/output (I/O) interface 201, a video summarization engine 202, a memory module 203, a navigation module 204, a content retrieval module 205, and a master summary generator 206.

The I/O interface 201 is configured to allow users to interact with the UE 101, to perform at least one function related to data management, data capture, and any related activities. The I/O interface 201 may be in any form, such as, but not limited to, a keypad or a touch screen display. Further, the I/O interface 201 provides users with at least one option to initiate and control any function associated with data capture and management. The I/O interface 201 may be associated with at least one component to capture media content, and/or may receive (or collect) contents from an external source. The external source may be internet, an external hard disk, and so on.

The video summarization engine 202 may identify action sequences in a received video, extract corresponding key frames, and generate summary frames corresponding to the video by using the extracted key frames. The term ‘key frame’ may refer to a frame that represents a unique scene (e.g., action scene) from the video being processed. According to an exemplary embodiment, the video summarization engine 202 automatically initiates the key frames when a new video is received and stored in the memory module 203. According to another exemplary embodiment, the video summarization engine 202 generates summary frames, in response to a user input.

The memory module 203 may store media contents of different types and/or different formats, in corresponding media databases, and provide the media contents to other components of the UE 101, to be further processed upon receiving a data request. In various exemplary embodiments, the memory module 203 may be located inside or outside the UE 101. Further, the memory module 203 may have a fixed size or may be a variable size (e.g., expandable). The memory module 203 may store summary frames generated corresponding to each video stored in the media databases, in the same database or different databases. The memory module 203 may support indexing of media content to support quick search and retrieval of the media content.

The navigation module 204 may perform video navigation. The video navigation process is intended to allow the user to quickly access a desired scene in the video. When a video is being played back, the navigation module 204 may provide key frames associated with the video to the user, based on the summary frames generated and stored for the video in the memory module 203. The navigation module 204 may receive an input from the user. The input may be associated with a selection of a particular key frame from the key frames provided to the user. Further, in response to the input from the user, the navigation module 204 redirects the user to a part of the video corresponding to the selected key frame.

The content retrieval module 205 may receive a search query from the user, wherein the search query may include at least a portion of at least one type of media file. According to an exemplary embodiment, the search query may be instantly generated by the user, based on a media content being viewed. For example, while watching a video file, the user may select a particular portion of the video by using any methods, and provide the selected portion as the search query. In response to the search query, the content retrieval module 205 searches for the contents stored in the memory module 203, for example, among the summary videos that are represented by a video library index. The summary videos may include videos that are extracted by using the summary frames. For example, the summary videos may be extracted based on a reproduction location of each summary frame. Next, the content retrieval module 205 identifies all or some of matching contents between the search query and the contents stored in the memory module 203. Further, the content retrieval module 205 may provide the identified matching contents to the user, using the I/O interface module 201.

The master summary generator 206 may generate, for two or more selected videos, a master summary including summary frames from the selected videos. The master summary generator 206 identifies key frames for the selected videos, from the summary frames generated for the selected videos, and generates the master summary for the selected videos by using the key frames. According to an exemplary embodiment, the master summary generator 206 receives a user input to select the videos to be used to generate the master summary. According to another exemplary embodiment, the master summary generator 206 automatically identifies and selects from the memory module 203, contents that are related to each other, and generates the master summary for the selected videos. The master summary generator 206 may identify related contents, based on at least one parameter, such as, but not limited to, a date and/or time at which the content has been generated and stored, and/or tagged.

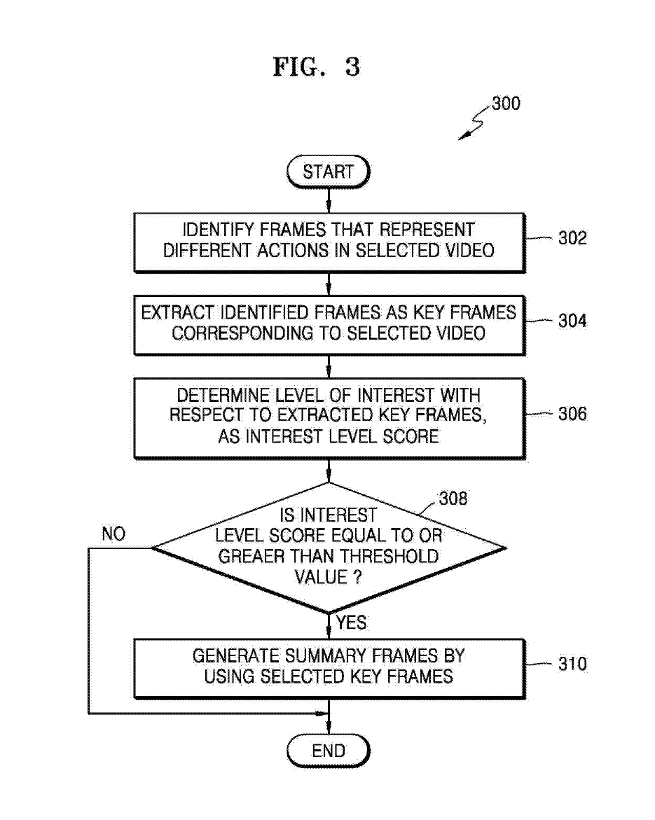

FIG. 3 is a flowchart of a method 300 of generating one or more of summary frames by using key frames.

When a video is selected, for example, automatically or based on a user instruction, the video summarization engine 202 identifies one or more frames that represent different actions in the selected video, in operation 302. Further, the video summarization engine 202 extracts the identified one or more frames as the key frames corresponding to the particular video (or the selected video), in operation 304.

After identifying the key frame(s), the video summarization engine 202 generates summary frames from the identified key frame(s), based on one or more pre-determined criterion. According to an exemplary embodiment, the pre-determined criterion may be an interest level score (or an interestingness score) of a key frame. The video summarization engine 202 determines a level of interest with respect to the extracted key frame(s), as an interest level score, in operation 306. According to an exemplary embodiment, the interest level score is determined based on at least one criterion that is preset by the user.

According to an exemplary embodiment, the interest level score may be determined based on the amount of new information present in a key frame to be considered. For illustrative purposes, it is assumed that, at time T, an M-th key frame is being processed, and a dictionary including N key frames (e.g., represented as having spatio-temporal features) is also available. The M-th key frame is compared with all of contents of the dictionary by using a preset matching criterion, and a number of matches between the M-th key frame and the contents of the dictionary is identified. In a case where a number of matching between the M-th Key frame and the contents of the dictionary exceeds a predefined threshold, the interest level score of the M-th key frame is set as ‘high’ (or set to have a high value).

Further, the M-th key frame may be added to the dictionary by removing an already existing key frame from the dictionary, thereby updating the dictionary. According to an exemplary embodiment, the key frame that matches most with the rest of the key frames in the dictionary is chosen to be removed. According to another exemplary embodiment, the dictionary is updated based on the interest level score of the key frame. For example, the interest level score of a new key frame is compared with the lowest interest level score of a key frame among all of key frames existing in the dictionary. When the interest level score of the new key frame is found to be higher than the lowest interest level score, the dictionary is updated by replacing the existing key frame having the lowest interest level score with the new key frame. When the number of matching between the M-th Key frame and the contents of the dictionary is lower than the predetermined threshold, the interest level score of the M-th key frame is set as ‘low’ (or set to have a low value), and the M-th key frame may not be added to the dictionary.

Further, the determined interest level score is compared with a threshold value of an interest level. For example, the threshold value of an interest level may be preset. In response to the determined interest level score being equal to or greater than the threshold value, the key frames corresponding to the interest level score are selected to generate the summary frames. Further, the summary frames are generated by using the selected key frames, in operation 310. The various operations in the method 300 may be performed in the order presented, in a different order, or simultaneously. Further, in some exemplary embodiments, some of the operations shown in FIG. 3 may be omitted and/or additional operations may be added in the method 300.

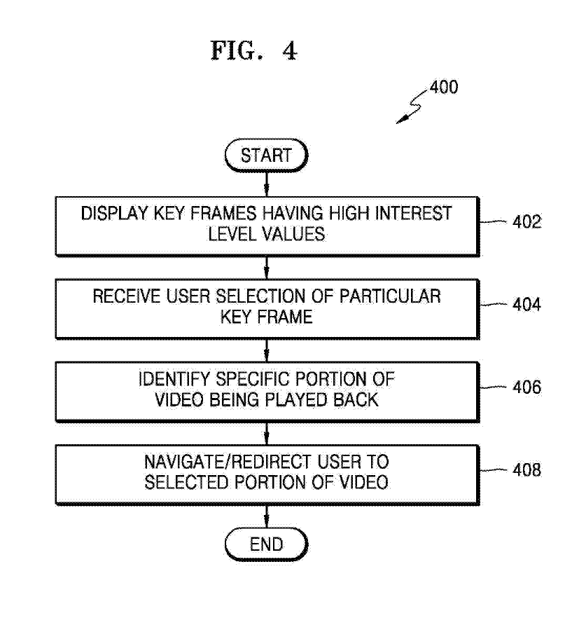

FIG. 4 is a flowchart of a method 400 of processing summary frames based on video navigation by using the UE according to an exemplary embodiment.

When a video is being played back, the navigation module 204 identifies key frames associated with the video, based on the summary frames generated and stored for the video in the memory module 203. According to an exemplary embodiment, only the key frames having higher interest level values are selected by the navigation module 204, and the selected key frames are provided to the user, in operation 402. The user may select at least one key frame from the key frames provided to the user, by using a corresponding user interface. The user interface may include a key pad, a dome switch, a touch pad including a capacitive overlay type, a resistive overlay type, an infrared beam type, a surface acoustic wave type, an integral strain gauge type, and a piezoelectric type, a jog wheel, a jog switch, etc., but exemplary embodiments are not limited thereto.

The navigation module 204 receives a user selection of a particular key frame in operation 404, and identifies a specific portion of the video being played back, from which the key frames are selected, in operation 406. Further, the navigation module 204 navigates or redirects the user to the selected portion of the video, in operation 408. The various operations in the method 400 may be performed in the order presented, in a different order, or simultaneously. Further, in some exemplary embodiments, some of the operations shown in FIG. 4 may be omitted and/or additional operations may be added in the method 400.

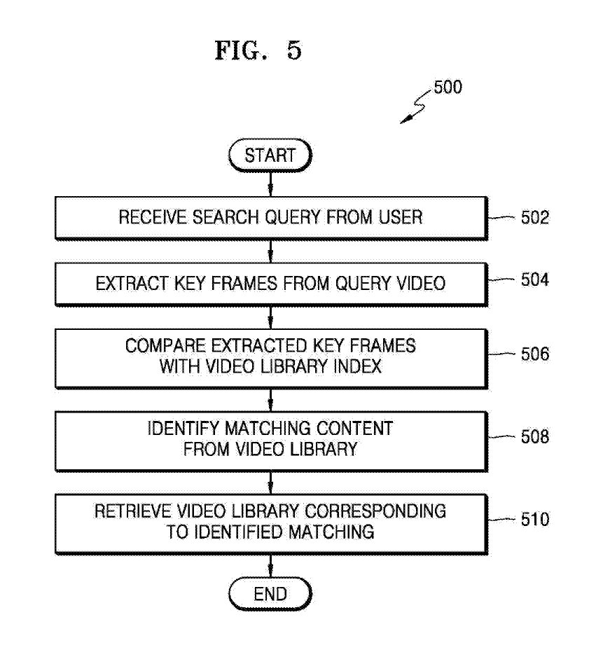

FIG. 5 is a flowchart of a method 500 of processing summary frames based on an action summary search by using a UE according to an exemplary embodiment.

The content retrieval module 205 in the UE 101 may receive a search query from the user, in operation 502. For example, the search query may include at least a portion of at least one type of a media file. For example, in a case where the user intends to search for all of videos from a media library (or video library), the search query may correspond to a portion of a video. For example, while watching a video file, the user may select a particular portion of the video by using options provided by the content retrieval module 205 and the I/O interface 201, and provide the selected portion as the search query.

In response to the search query, the content retrieval module 205 extracts key frames from a query video (or selected portion of the video) in operation 504, and compares the extracted key frames with a video library index (or index of the video library), in operation 506. By comparing the key frames with the video library index, the content retrieval module 205 identifies matching content from a video library in operation 508, and retrieves the same, in operation 510. Further, the identified matching content may be displayed to the user. For example, when the query video corresponds to shooting of a penalty kick in a football game, the content retrieval module 205 searches and identifies all of videos in the video library that has at least one similar key frame (e.g., a frame that displays shooting of the penalty kick), and displays the search result to the user.

The various operations in the method 500 may be performed in the order presented, in a different order, or simultaneously. Further, in some exemplary embodiments, some of the operations shown in FIG. 5 may be omitted and/or additional operations may be added to the method 500.

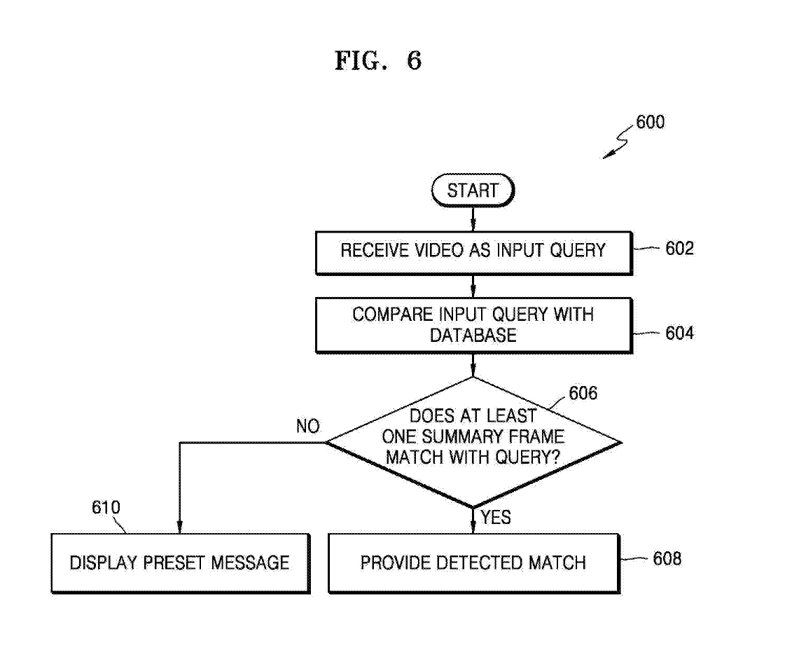

FIG. 6 is a flowchart of a method 600 of using summary frames to perform a feature of moment recall.

The term ‘moment recall’ refers to a feature that allows obtaining video summary frames that match an input query. For example, the input query is an image. The UE 101 initiates the moment recall feature in response to receiving an image as an input query, in operation 602. Further, the UE 101 compares the received input query with a database in an associated storage space, in which summary frames corresponding to at least one video are stored, in operation 604.

By comparing the input query with the summary frames in the database, it is determined whether at least one summary frame matches with the input query, in operation 606. Any image and/or a video processing and comparison algorithm may be used to compare the input query with the summary frames. In various exemplary embodiments, parameters, such as, but not limited to, a time stamp, and a geo tag associated with the input query, as well as the summary frames, may be used to identify a match as a result of comparison.

When at least one match is detected, the detected match is provided as an output in a predetermined format, in response to the input query, via at least one interface, in operation 608. If no match is found, a preset message indicating that no match is found is displayed to the user by using an interface, in operation 610.

The various operations in the method 600 may be performed in the order presented, in a different order or simultaneously. Further, in some exemplary embodiments, some of the operations shown in FIG. 6 may be omitted and/or additional operations may be added to the method 600.

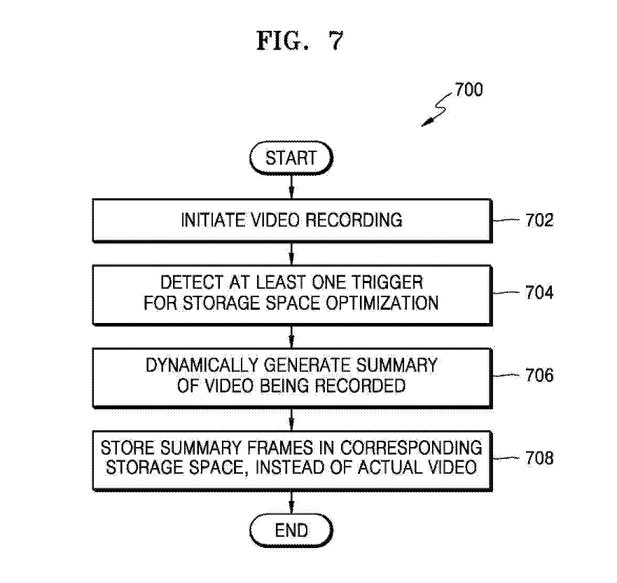

FIG. 7 is a flowchart of a method 700 of using summary frames to perform storage space enhancement, according to an exemplary embodiment.

In operation 702, the user may initiate video recording by using the UE 101. The UE 101 may be configured to monitor recording of the video. In operation 704, the UE 101 detects at least one trigger of a pre-defined type, to perform storage space enhancement. For example, the trigger may be an event in which the available storage space becomes less than or equal to a set value, i.e., a threshold limit of a storage space which has been preset with the UE 101. Further, the trigger may be at least one of or a combination of manual inputs provided by the user, and the event in which the available storage space becomes less than a threshold value and/or may be any event as pre-defined by the user.

Upon receiving at least one trigger to enhance the storage space, the UE 101 dynamically generates a summary (or summary frames) of the video being recorded in operation 706, and stores the summary (or summary frames) in the corresponding storage space, instead of the actual video, in operation 708.

The various operations in the method 700 may be performed in the order presented, in a different order or simultaneously. Further, in some embodiments, some of the operations shown in FIG. 7 may be omitted and/or additional operations may be added to the method 700.

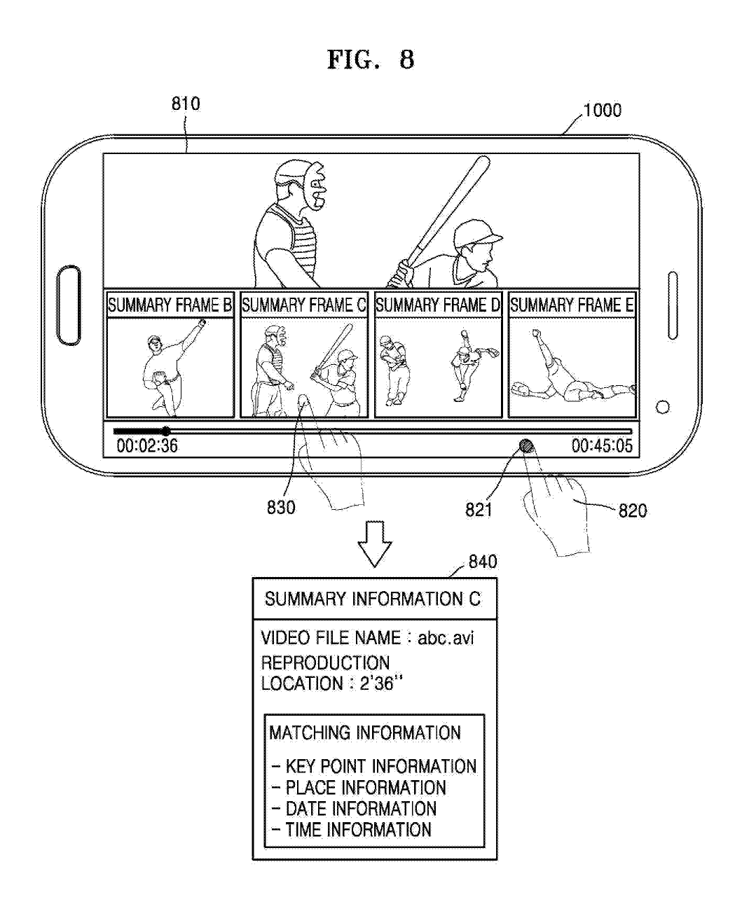

FIG. 8 is a schematic view for explaining providing summary frames by summarizing a video input to an electronic device 1000, according to an exemplary embodiment.

The electronic device 1000 may analyze the input video and determine summary frames based on a relatively large change in an image. For example, the electronic device 1000 may determine frames having a relatively large amount of change in a feature such as a position or a shape of an object in an image, as summary frames. The electronic device 1000 may display a video 810, and may also display summary frames including summary frame B, summary frame C, summary frame D, and summary frame E, together with the video 810. When a user selects one summary frame (e.g., summary frame C) from the summary frames, the electronic device 1000 may reproduce the video 810 from a reproduction location of the selected summary frame.

According to an exemplary embodiment, the electronic device 1000 determines summary frames of the video 810 and provides the determined summary frames to the user. Therefore, the user may easily search for a desired reproduction location from the video 810. Referring to FIG. 8, the electronic device 1000 may display the input video 810. The electronic device 1000 may also display the summary frames B-E. The electronic device 1000 may display the summary frames B-E together with the input video 810, but exemplary embodiments are not limited thereto.

The electronic device 1000 may acquire key frames and determine the summary frames from among the acquired key frames. In response to a user input 820, the electronic device 1000 may display the summary frames. For example, when the user touches a displayed icon 821, the electronic device 1000 may display the summary frames. The electronic device 1000 may display, on the input video 810, the summary frames in response to the user input 820.

The electronic device 1000 may receive a user input 830 of selecting one from among the displayed summary frames.

The electronic device 1000 may generate summary information about the summary frames. The summary information includes information about the summary frames. For example, the summary information may include the name of a video file including the summary frames, reproduction locations of the summary frames, a reproduction location of a next key frame, and matching information that is used to perform content search. Summary information may be generated for each summary frame. For example, summary information C 840 is information about a summary frame C. The summary information C 840 includes a video file name, a reproduction location, and matching information for the summary frame C. The video file name is an identity (ID) value of the video 810. For example, the video file name may be displayed as abc.avi. The reproduction location of the summary frame C indicates the time at which the summary frame C in the video 810 is reproduced in the video 810.

The matching information may include key point information, place information, and date and time information, and may further include any information that may be used to search for a summary frame that is the same as or similar to the frame corresponding to the matching information. For example, the key point information may include information about a key point of the summary frame, the place information may include information of a place in which a video including the summary frame has been captured, and the date and time information may include information about a date and time at which the video including the summary frame has been captured.

The electronic device 1000 may be any device capable of performing image processing. Examples of the electronic device 1000 may include, but are not limited to, a smartphone, a tablet personal computer (PC), a PC, a smart television (TV), a mobile phone, a personal digital assistant (PDA), a laptop, a media player, a micro-server, a global positioning system (GPS) device, an electronic book terminal, a digital broadcasting terminal, a navigation device, a kiosk, an MP3 player, a digital camera, home appliances, and other mobile or non-mobile computing devices. The electronic device 1000 may also be a wearable device such as a watch, glasses, a hair band, or a ring that has a communication function and/or a data processing function.

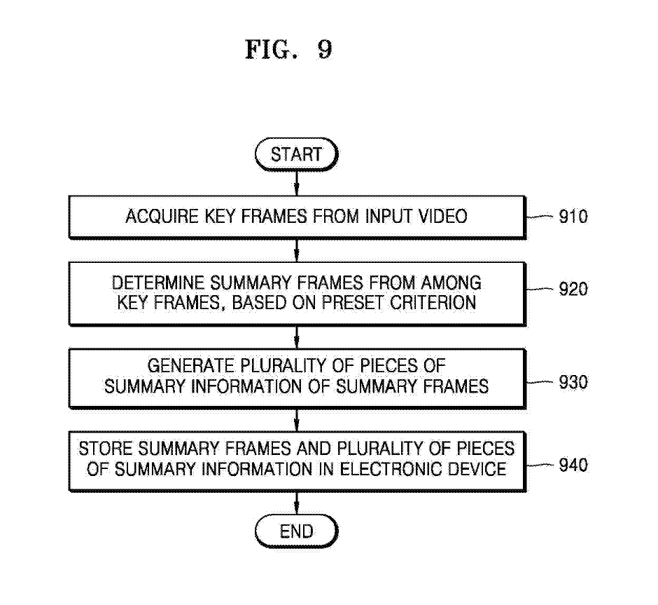

FIG. 9 is a flowchart of a method of generating summary information of summary frames, according to an exemplary embodiment.

In operation 910, an electronic device may acquire key frames from an input video. The input video of the electronic device may be a video generated by the electronic device. For example, the input video may be a video captured by a camera of the electronic device. The video input to the electronic device may also be a video received by the electronic device from an external server (for example, a cloud server) or from an external electronic device. The video input to the electronic device may include the key frames. The key frames included in the input video may be still frames of an image. In other words, the key frames may be an image file. The key frames acquired by the electronic device may be displayed as a thumbnail.

In operation 920, the electronic device may determine summary frames from among the key frames, based on a preset criterion. According to an exemplary embodiment, the preset criterion may be based on a variation in a particular key frame compared with other key frames. For example, key frames in which pixel values of an entire screen have changed by a preset threshold degree or greater, key frames in which a new object appears, or key frames in which an action of an object has changed by a preset threshold value or greater may be determined as the summary frames, from among the key frames.

When the electronic device determines a plurality of summary frames from among key frames belonging to a certain reproduction section, the electronic device may restrict the number of the determined summary frames. For example, the electronic device may determine one summary frame from among the key frames belonging to a ten-minute long section of the input video.

For example, when the video input to the electronic device includes N key frames, the electronic device may compare a given key frame (e.g., key frame A) with the remaining (N−1) key frames. The electronic device may compare the key frames with one another by using a spatio-temporal feature of the key frames. The electronic device may also compare the key frames with one another by using key points of the key frames. The electronic device may also compare the key frames with one another by using at least one of the time information and the place information included in the key frames. If it is determined that, based on the comparison between the key frame A and the remaining (N−1) key frames, a variation in the key frame A is equal to or greater than a preset threshold value, the electronic device may determine the key frame A as a summary frame. The electronic device may determine the summary frames by comparing each of the N key frames included in the input video with the remaining (N−1) key frames.

In operation 930, the electronic device may generate a plurality of pieces of summary information of the summary frames. Summary information includes, for example, a video file name, a reproduction location, and matching information.

In operation 940, the electronic device may store the summary frames and the plurality of pieces of summary information in a memory or an external storage (e.g., cloud). The electronic device may associate the plurality of pieces of summary information to the summary frames.

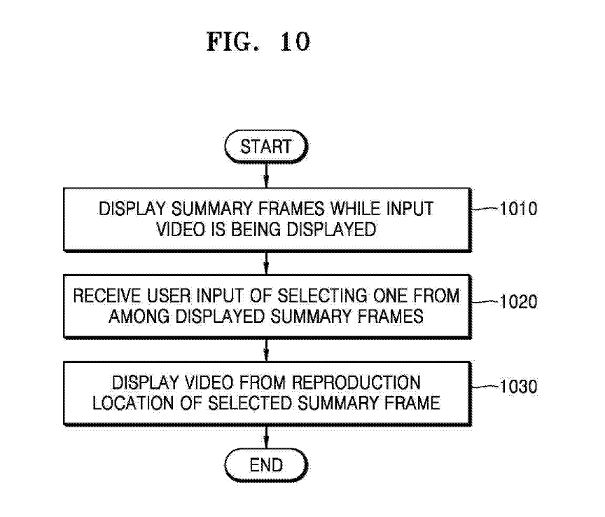

FIG. 10 is a flowchart of a method of displaying a video from a selected summary frame, according to an exemplary embodiment.

In operation 1010, when the input video is being displayed, the electronic device may display the summary frames. According to an exemplary embodiment, the electronic device may display the summary frames together with the input video. The electronic device may display the determined summary frames together with the input video, in response to a user input. The summary frames may be displayed on a certain area of the screen. For example, the summary frames may be displayed on a lower portion, a left portion, or a right portion of the screen.

According to another exemplary embodiment, when a plurality of summary frames are determined, the electronic device may display some of the determined summary frames without a user input. The electronic device may display other summary frames in response to a user input.

In operation 1020, the electronic device may receive a user input of selecting one from among the displayed summary frames. The electronic device may receive a user input of selecting a plurality of summary frames from among the displayed summary frames.

In operation 1030, the electronic device may display a video from a reproduction location of the selected summary frame. The electronic device may display a video corresponding to the reproduction location of the selected summary frame, but exemplary embodiments are not limited thereto. When a video is being reproduced on the electronic device, the electronic device may reproduce the video corresponding to the reproduction location of the selected summary frame. When a video is in a hold state (e.g. displaying a still image) on the electronic device, the electronic device may display a still image of the video corresponding to the reproduction location of the selected summary frame.

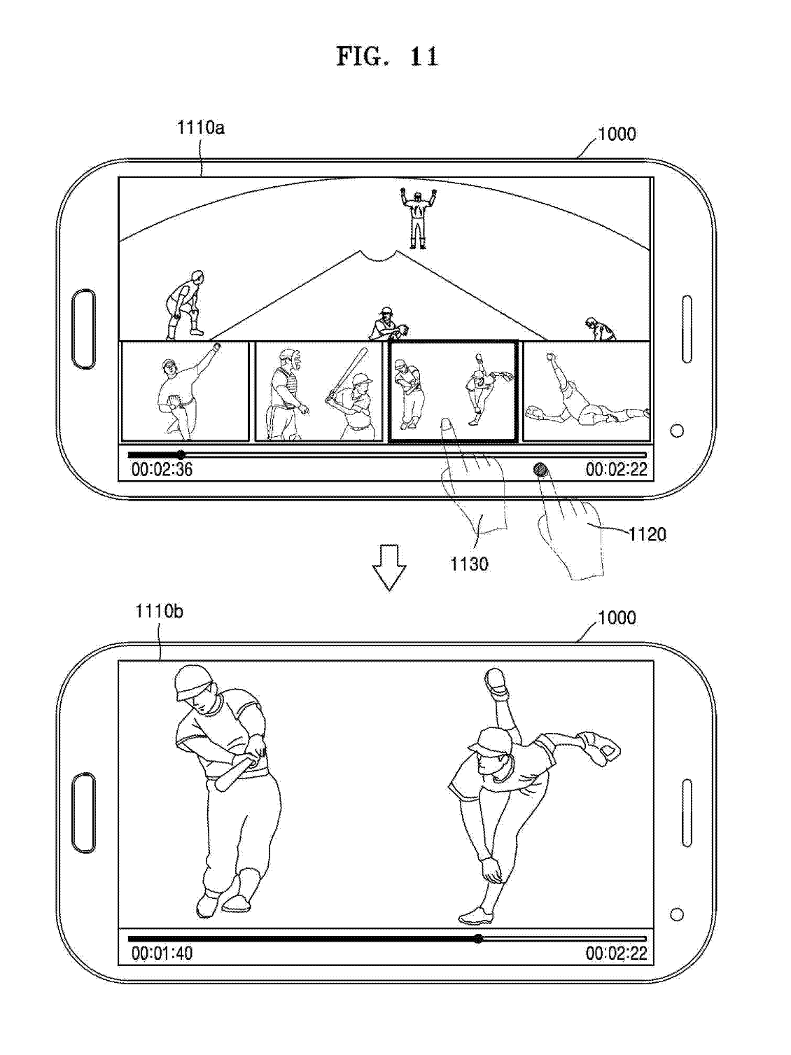

FIG. 11 illustrates an example of displaying a video from a selected summary frame, according to an exemplary embodiment.

Referring to FIG. 11, when an input video 1110a is being displayed on the electronic device 1000, the electronic device 1000 may display a plurality of summary frames. The plurality of summary frames may be located on a lower portion of the screen. In response to a user input 1120, the electronic device 1000 may display the summary frames. The electronic device 1000 may receive a user input 1130 of selecting one from the displayed summary frames.

In response to the user input 1120 of selecting one from the displayed summary frames, the electronic device 1000 may reproduce an input video 1110b from a reproduction location of the selected summary frame.

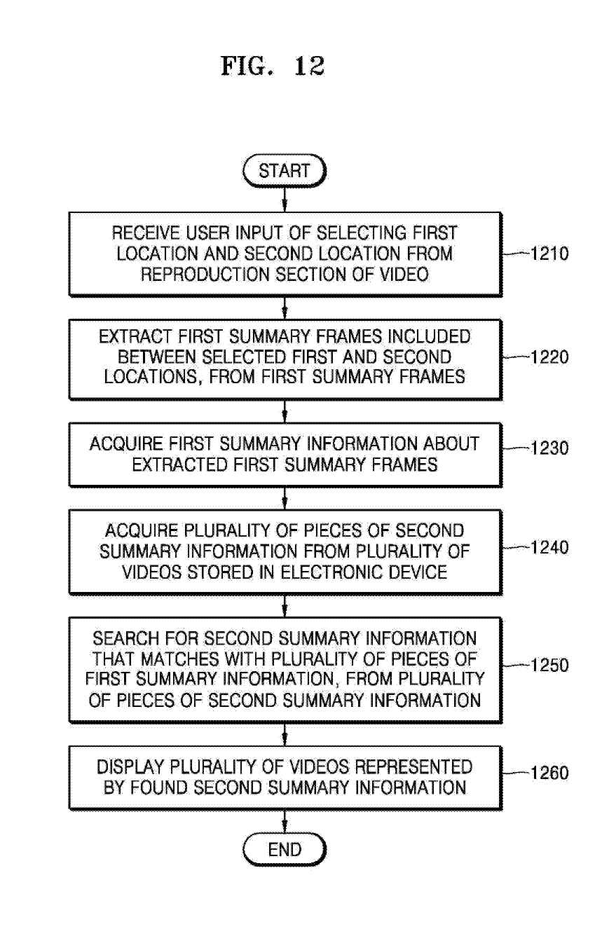

FIG. 12 is a flowchart of a video searching method according to an exemplary embodiment.

Referring to FIG. 12, the electronic device may provide the user with a video that is similar to a currently reproduced video, by using the summary information of the summary frames.

In operation 1210, the electronic device may receive a user input of selecting a first location and a second location from a reproduction time section of a video. For example, the reproduction section may indicate a dynamic progress of a video being reproduced and may be represented on a lower portion of the video, for example, in a bar shaped graphic (or time indicator). According to an exemplary embodiment, the electronic device may receive a user input of selecting only the first location from the reproduction section of the video. When a user input selects only the first location, the electronic device may automatically determine, for example, a starting location of the video as the second location. When a user input selects only the first location, the electronic device may automatically determine, for example, an ending location of the video as the second location.

According to an exemplary embodiment, the electronic device may receive a user input of selecting a plurality of sets of a first location and a second location.

According to an exemplary embodiment, instead of selecting the first and second locations from the reproduction section of the video, the electronic device may receive a user input of selecting two frames from first summary frames included in the video. For example, the electronic device may receive a user input of selecting two frames from the first summary frames displayed together with the video. A reproduction location of a first summary frame that is reproduced earlier than the other selected first summary frame, from among the two first summary frames selected by the user, is determined as the first location, and a reproduction location of the remaining first summary frame is determined as the second location.

The first summary frames are selected from the frames of the currently reproduced video. Second summary frames are selected from the frames of a video stored in the memory. According to another exemplary embodiment, the second summary frames may be selected from a section not designated by the user in the currently reproduced video.

In operation 1220, the electronic device may extract first summary frames included between the selected locations, from the first summary frames. The electronic device may display the extracted first summary frames. The extracted first summary frames may include ID values that are distinguished from non-extracted first summary frames.

According to an exemplary embodiment, in response to the plurality of sets of the first location and the second location, the electronic device may extract the first summary frames included in each set. The electronic device may display the extracted first summary frames. The extracted first summary frames may include ID values that are distinguished from non-extracted first summary frames. The first summary frames included in each set may include ID values that are distinguished from the first summary frames included in another set.

According to an exemplary embodiment, when the electronic device receives a user input of selecting two first summary frames instead of selecting the first and second locations from the reproduction section of the video, the electronic device may extract first summary frames included between the reproduction locations of the two selected first summary frames.

In operation 1230, the electronic device may acquire summary information about the extracted first summary frames. The electronic device may acquire first summary information for each of the first summary frames. In operation 1240, the electronic device may acquire a plurality of pieces of second summary information from a plurality of videos stored in the electronic device. The electronic device may acquire second summary information from the video including the first summary frames. The electronic device may acquire, from the video, second summary information about frames except for the frames included between the first location and the second location. The electronic device may acquire second summary frames from among the key frames included in the plurality of videos. The electronic device may generate and acquire the plurality of pieces of second summary information of the second summary frames. The plurality of pieces of second summary information may include information having the same types as the plurality of pieces of first summary information. For example, the plurality of pieces of second summary information may include information of any one of a video file name, a reproduction location, and matching information.

In operation 1250, the electronic device may search for second summary information that matches with the plurality of pieces of first summary information, from the plurality of pieces of second summary information. The electronic device may search for second summary information that matches with the plurality of pieces of first summary information, by using matching information included in the plurality of pieces of first summary information and matching information included in the plurality of pieces of second summary information.

According to an exemplary embodiment, the electronic device may search for second summary information that matches with the plurality of pieces of first summary information, via vision recognition. The electronic device may match the plurality of pieces of first summary information with the plurality of pieces of second summary information by using key point information included in the plurality of pieces of first summary information and the plurality of pieces of second summary information. Examples of a method of performing matching by using the key point information include, but are not limited to, Harris corner, Shi & Tomasi, SIFT DoG, FAST, and AGAST algorithms. The electronic device may search for second summary information that matches with the plurality of pieces of first summary information, by using a vision recognition algorithm and a region tracking algorithm.

According to another exemplary embodiment, the electronic device may search for second summary information that matches with the plurality of pieces of first summary information, by using place information and data and time information included in the plurality of pieces of first summary information and the plurality of pieces of second summary information. The electronic device may search for a plurality of pieces of second summary information including place information that matches with the place information included in the plurality of pieces of first summary information. The electronic device may search for a plurality of pieces of second summary information including date and time information that matches with the date and time information included in the plurality of pieces of first summary information. The place information may be GPS information of a place where a video including the plurality of pieces of first summary information has been captured. The date and time information may be information about the date and time at which the video including the plurality of pieces of first summary information has been captured. However, the place information and the date and time information are not limited thereto.

According to an exemplary embodiment, the electronic device may receive a user input of selecting some of the areas of the first summary frames. When some areas are selected from the areas of the first summary frames, the electronic device may identify a plurality of pieces of first summary information of first summary frames corresponding to the selected areas, and search for second summary information that match with the identified first summary information. For example, the electronic device may search for a plurality of pieces of matched second summary information by using only key point information of the selected areas, but exemplary embodiments are not limited thereto.

In operation 1260, the electronic device may display a plurality of images of videos represented by found second summary information. According to an exemplary embodiment, the electronic device may display second summary frames corresponding to the found second summary information. The electronic device may split the screen into regions and display the second summary frames on the regions of the screen. For example, the electronic device may split the screen into twelve regions and display twelve second summary frames on the twelve regions. The user may select one from the displayed second summary frames, and the electronic device may reproduce a video including the selected second summary frame. At this time, the electronic device may reproduce the video from a reproduction location of the selected second summary frame.

According to an exemplary embodiment, the electronic device may display the plurality of pieces of second summary information, based on matching values between the plurality of pieces of second summary information and the plurality of pieces of first summary information. The electronic device may calculate matching values of the plurality of pieces of second summary information. The electronic device may display images (or key frames or summary frames) of videos including a plurality of pieces of second summary information that satisfy a preset condition. For example, when the plurality of pieces of second summary information have higher matching values, the plurality of pieces of second summary information may have higher matching degrees with respect to the plurality of pieces of first summary information. The electronic device may display images of videos including a plurality of pieces of second summary information having matching values that are equal to or greater than a threshold value. For example, the electronic device may preferentially display images of videos including a plurality of pieces of second summary information having high matching values.

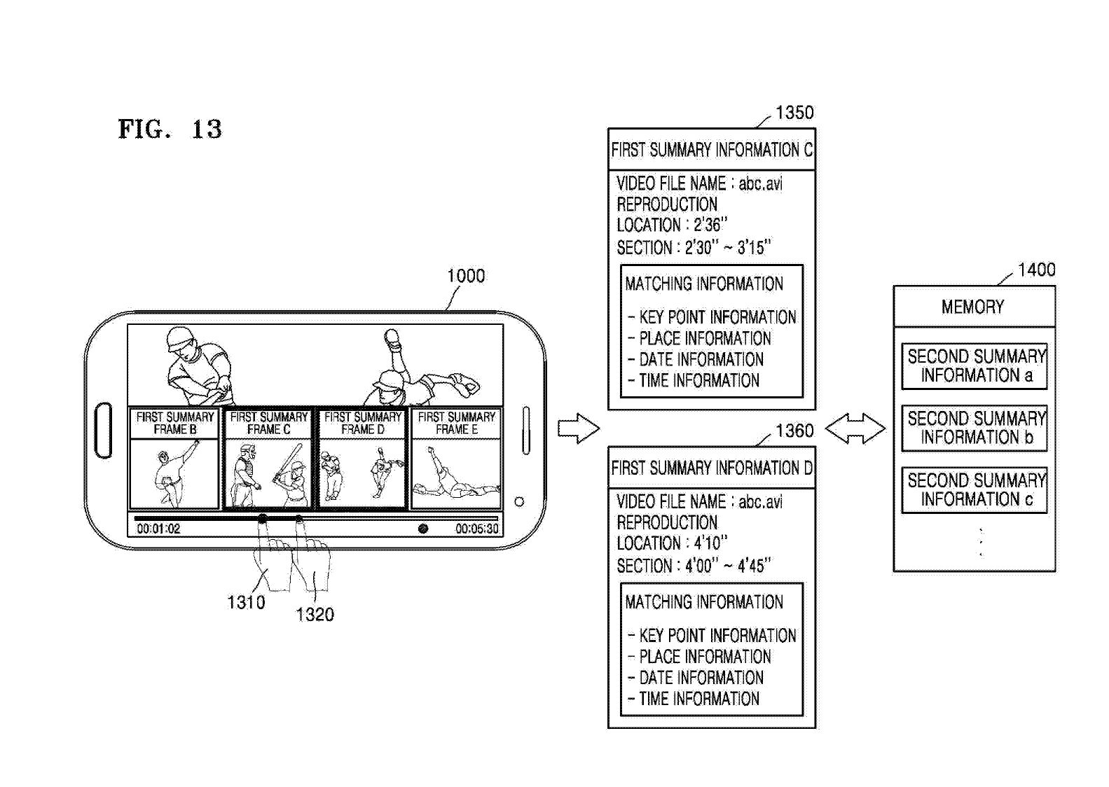

FIG. 13 is a flowchart of a method of searching for a video that matches with a reproduction section of a video, according to an exemplary embodiment.

Referring to FIG. 13, the electronic device 1000 may receive a user input of selecting a first location 1310 and a second location 1320 from a video reproduction section. The electronic device 1000 may extract first summary frames included between the selected first and second locations 1310 and 1320, and the extracted first summary frames may include ID values. In FIG. 13, first summary frame C and first summary frame D included between the first and second locations 1310 and 1320 are extracted as first summary frames.

The electronic device 1000 may acquire a plurality of pieces of first summary information of the extracted first summary frames. For example, the first summary information C 1350 or the first summary information D 1360 may include video file names, reproduction locations, and pieces of matching information. The pieces of matching information may include key point information, time information, and place information. The first summary information C 1350 represents the first summary frame C. The first summary information D 1360 represents the first summary frame D.

The electronic device 1000 may search for second summary information that matches with the plurality of pieces of first summary information, from a plurality of pieces of second summary information stored in a memory 1400.

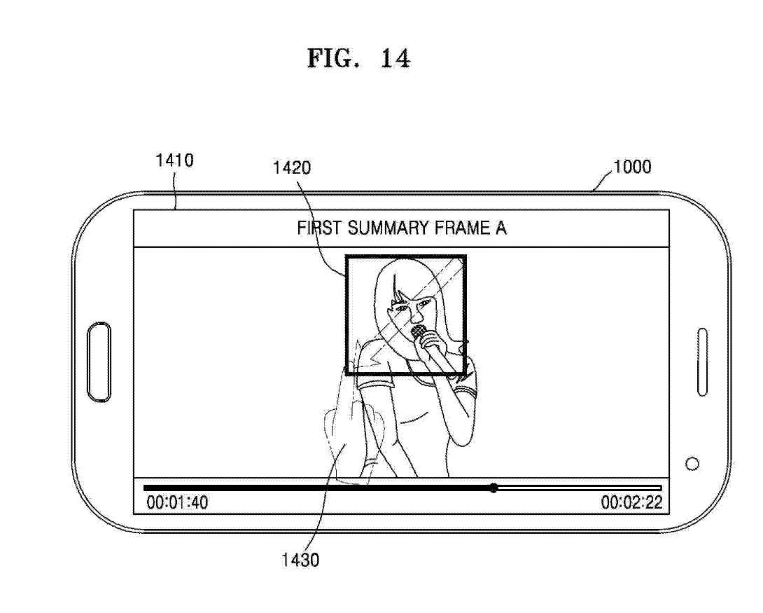

FIG. 14 illustrates an example of selecting a partial area of a first summary frame, according to an exemplary embodiment.

The electronic device 1000 may receive a user input 1430 of selecting a partial area 1420 from a first summary frame 1410. As shown in FIG. 14, the user input 1430 may be touching and dragging and a user may select the partial area 1420 via the touching and dragging.

The electronic device 1000 may acquire a plurality of pieces of first summary information corresponding to partial areas of selected first summary frames. The plurality of pieces of acquired first summary information may be, but are not limited to, key point information about the partial areas of the selected first summary frames.

The aforementioned operations may be followed by operations that are the same as or similar to operations 506 to 510 of FIG. 5. Thus, since the subsequent operations are the same as or similar to operations 506 to 510 of FIG. 5, descriptions thereof will be omitted for convenience of explanation.

According to an exemplary embodiment, the electronic device 1000 may identify that a face is included in the selected partial area 1420, by using key point information of the selected partial area 1420. The electronic device 1000 may search for a video including a frame that matches with the identified face. For example, a face recognition algorithm may be used to search for the video including the frame that matches with the identified face. The electronic device 1000 may detect a face from the selected partial area 1420, extract features of the detected face by using the key point information, and search for second summary information including information that matches with the extracted face features.

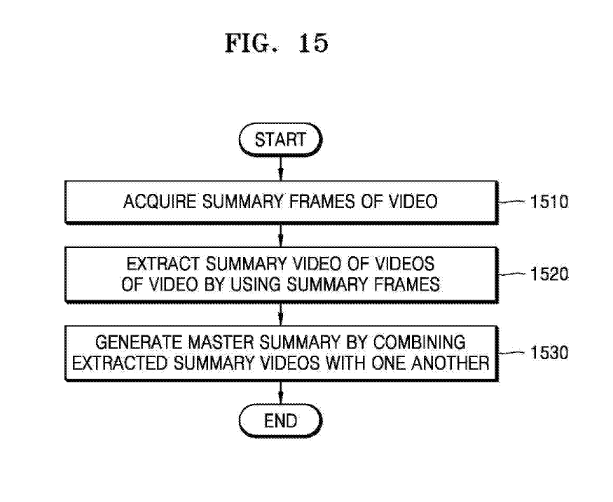

FIG. 15 is a flowchart of a method of generating a master summary of a plurality of videos, according to an exemplary embodiment. Referring to FIG. 15, the electronic device may generate a master summary by extracting some videos from a plurality of videos and combining the extracted videos with one another. The user may reproduce the master summary and thus may watch major portions of the plurality of videos within a short period of time.

In operation 1510, the electronic device may acquire a summary frame of a video. According to an exemplary embodiment, the electronic device may acquire summary frames of a plurality of videos. For example, the plurality of videos may be videos captured within a time period designated by the user or may be videos selected by the user. Alternatively, the plurality of videos may be videos included in the same folder. Alternatively, the plurality of videos may be videos including the same or similar file names.

In operation 1520, the electronic device may extract summary videos of the videos by using the summary frames. According to an exemplary embodiment, the electronic device may extract summary videos of the plurality of videos by using the summary frames. The electronic device may extract the summary videos by extracting videos from a reproduction location of each summary frame to a reproduction location of a next key frame. For example, the summary video may be extracted to have a certain length of reproduction with respect to the reproduction location of each summary frame (e.g., a thirty-second reproduction period from the reproduction location of a summary frame).

In operation 1530, the electronic device generates the master summary by combining the extracted summary videos with one another. For example, the electronic device may locate a summary video of a temporally earlier-input video in an earlier chronological position of the master summary.

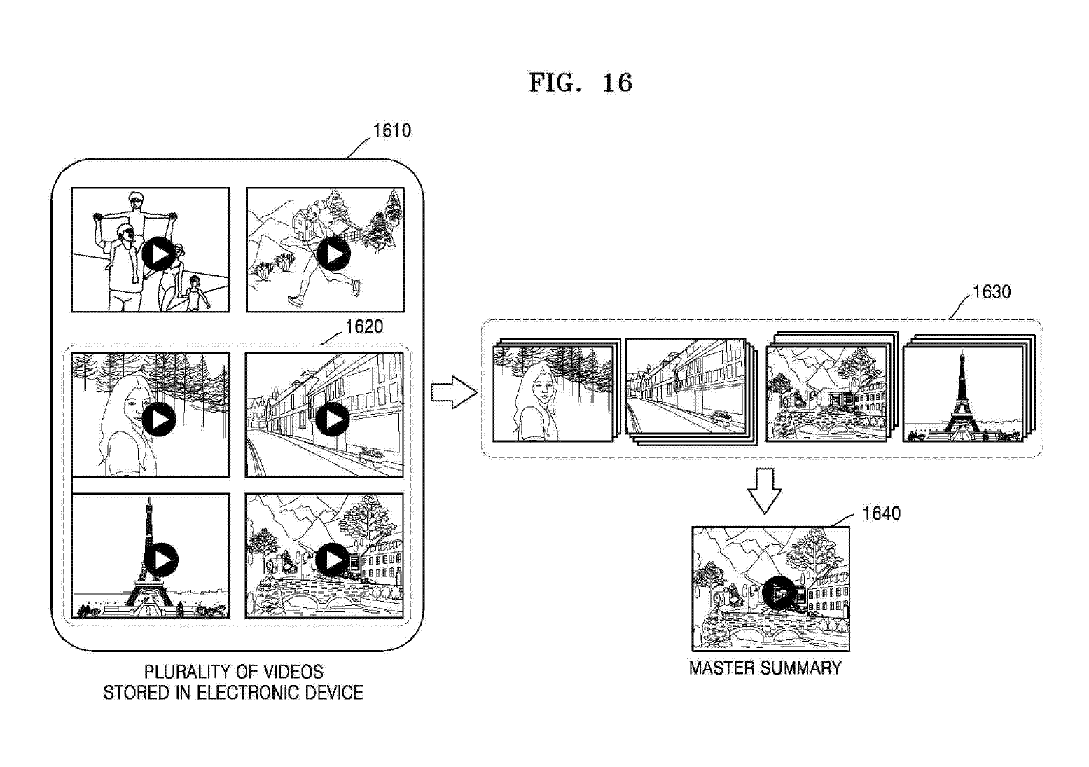

FIG. 16 is a schematic view for explaining a method of generating a master summary of a plurality of videos, according to an exemplary embodiment.

Referring to FIG. 16, the electronic device may include a plurality of videos 1610 stored in the memory. The electronic device may acquire summary frames 1630 included in videos 1620 generated during a specific time period, from among the plurality of videos 1610. For example, the user may select videos captured during a recent travel period from among the plurality of videos stored in the electronic device, and the electronic device may acquire summary frames of the videos selected by the user.

The electronic device may extract summary videos by using the acquired summary frames 1630. The electronic device may generate the master summary by combining the extracted summary videos with one another, thereby providing the user with partial videos of interest of the user in the form of a single video file.

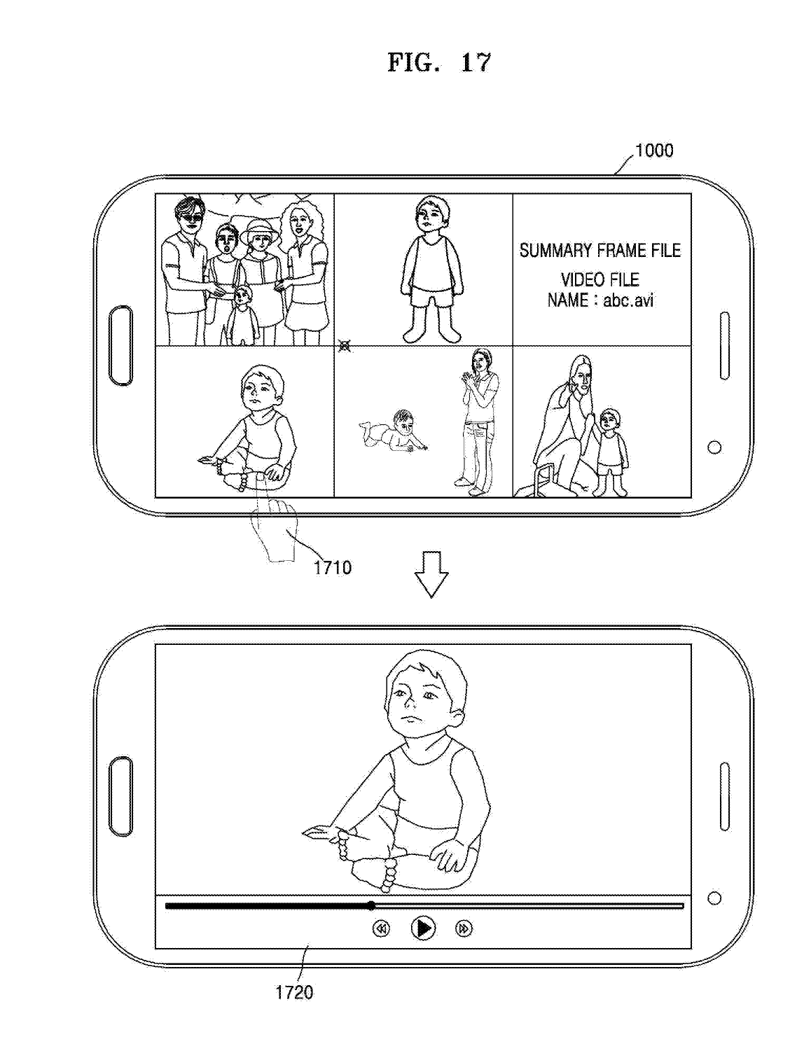

FIG. 17 illustrates an example of a method of displaying a video from a reproduction location of a selected summary frame, according to an exemplary embodiment. The electronic device 1000 may display summary frames and may display a video from a reproduction location of a summary frame selected by the user.

The electronic device 1000 may display a plurality of stored summary frames. The electronic device 1000 may display a plurality of summary frames included in a single video file. Alternatively, the electronic device 1000 may display summary frames that respectively represent a plurality of videos. According to an exemplary embodiment, the electronic device 1000 may display the summary frames, based on a preset criterion. For example, the electronic device 1000 may display the summary frames in the order in which the summary frames are reproduced within a video. The electronic device 1000 may determine locations at which the summary frames for the plurality of videos are displayed in sequence of dates when the plurality of images are stored.

The electronic device 1000 may receive a user input 1710 of selecting the displayed summary frames. In response to the user input 1710, the electronic device 1000 reproduces a video from a reproduction location 1720 of a displayed summary frame.

The electronic device 1000 may acquire a plurality of pieces of summary information of selected summary frames. The plurality of pieces of summary information may include, but are not limited to, information about reproduction location of the summary frames.

The electronic device 1000 may also display a video from the reproduction location 1720 included in the plurality of pieces of summary information, but the location at which the video is displayed is not limited thereto.

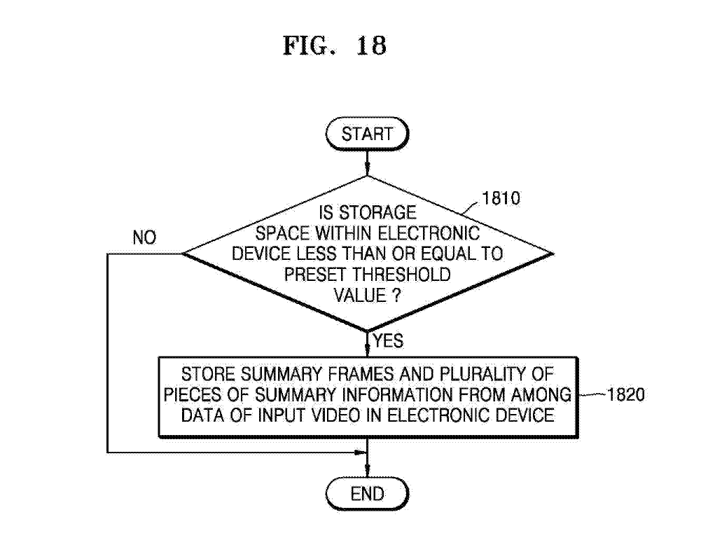

FIG. 18 is a flowchart of a method of storing a portion of an input video, according to an exemplary embodiment.

Referring to FIG. 18, the electronic device may store only a portion of a captured video, when a storage space of the electronic device is insufficient.

In operation 1810, the electronic device may determine whether the storage space is less than or equal to a preset threshold value. The storage space may be, but is not limited to, a memory of the electronic device. When it is not determined in operation 1810 that the storage space is less than or equal to the preset threshold value, the electronic device may store the entire input video in the storage space.

On the other hand, when it is determined in operation 1810 that the storage space is less than or equal to the preset threshold value, the electronic device may provide notification information, notifying the storage space being less than or equal to the preset threshold value, to the user. The electronic device may proceed to operation 1820, in response to a user input with respect to the notification information. However, according to an exemplary embodiment, even when it is not determined in operation 1810 that the storage space is less than or equal to the preset threshold value, the electronic device may proceed to operation 1820, in response to a user input.

In operation 1820, the electronic device may store summary frames and a plurality of pieces of summary information from among data of the input video. According to an exemplary embodiment, in response to the user input with respect to the notification information, the electronic device may receive an input of storing only the summary frames and the plurality of pieces of summary information in the storage space. Further, in response to the user input with respect to the notification information, the electronic device may delete portions of the input video data except for the summary frames and the plurality of pieces of summary information from the storage space.

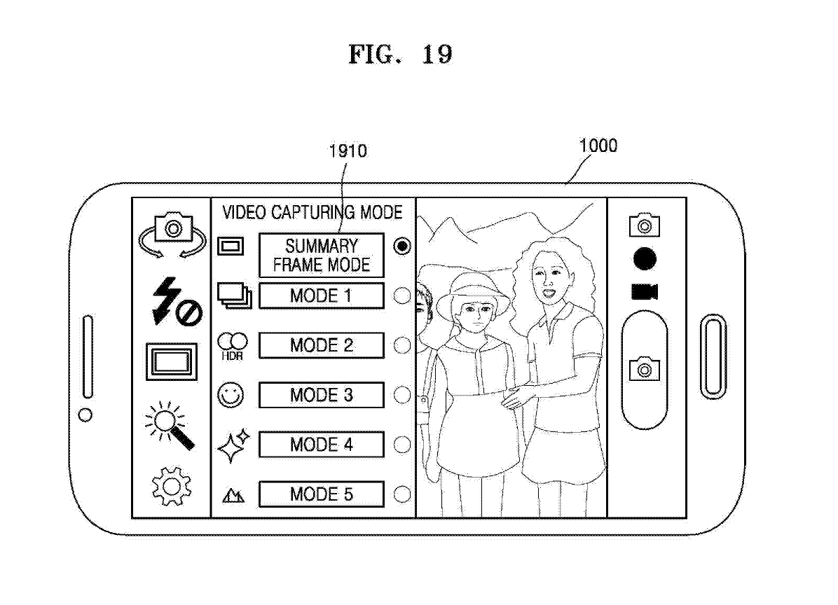

FIG. 19 illustrates an example of selecting a method of storing a video, according to an exemplary embodiment.

Referring to FIG. 19, the user may capture a video by using the electronic device 1000. The electronic device 1000 may receive a user input of selecting a summary frame mode 1910 from among a plurality of video capturing modes. In response to a user input of selecting the summary frame mode 1910, the electronic device 1000 may store summary frames and a plurality of pieces of summary information acquired from the captured video in a storage space of the electronic device 1000. Further, in response to the user input of selecting the summary frame mode 1910, the electronic device 1000 may delete portions of data corresponding to the captured video except for the summary frames and the plurality of pieces of summary information from the storage space.

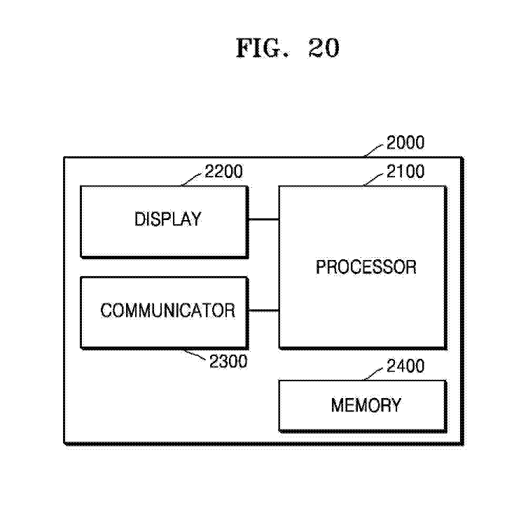

FIG. 20 is a block diagram of an electronic device 2000 according to an exemplary embodiment.

Referring to FIG. 20, the electronic device 2000 may include a processor 2100, a display 2200, a communicator 2300, and a memory 2400. Not all of the components illustrated in FIG. 20 may be essential components of the electronic device 2000. More or less components than those illustrated in FIG. 20 may be included in the electronic device 2000.

For example, the electronic device 2000 may further include a user input unit, an output unit, a sensing unit, and an audio/video (A/V) input unit.

The user input unit may receive data input by a user to control the electronic device 2000. For example, the user input unit may be, but is not limited to, a key pad, a dome switch, a touch pad (e.g., a capacitive overlay type, a resistive overlay type, an infrared beam type, an integral strain gauge type, a surface acoustic wave type, a piezo electric type, or the like), a jog wheel, or a jog switch.

The output unit may output an audio signal, a video signal, or a vibration signal.

The display 2200 may display information that is processed by the electronic device 2000. For example, the display 2200 may store a video input to the electronic device 2000.

When the display 2200 forms a layer structure together with a touch pad to construct a touch screen, the display 2200 may be used as an input device as well as an output device. The display 2200 may include at least one of a liquid crystal display (LCD), a thin film transistor-liquid crystal display (TFT-LCD), an organic light-emitting diode (OLED), a flexible display, a three dimensional (3D) display, and an electrophoretic display. According to exemplary embodiments of the electronic device 2000, the electronic device 2000 may include at least two displays 2200. For example, the at least two displays 2200 may be disposed to face each other by using a hinge.

The processor 2100 may control operations of the electronic device 2000. For example, the processor 2100 may control the user input unit, the output unit, the sensing unit, the communicator 2300, the A/V input unit, and the like by executing programs stored in the memory 2400. The processor 2100 may control the user input unit, the output unit, the sensing unit, the communicator 2300, the A/V input unit, and the like to execute an operation of the electronic device 2000.

The above-described operations according to the exemplary embodiments may be performed by the electronic device 2000.

The processor 2100 may determine frames having relatively large image changes as summary frames, by analyzing the video. The display 2200 may display a video and may also display the summary frames together with the video. When the communicator 2300 receives a user input of selecting one from the summary frames, the processor 2100 may reproduce the video from a reproduction location of the selected summary frame. Because the processor 2100 determines summary frames of the video, by using the key frames, and provides the determined summary frames to the user, the user may easily search for a desired reproduction location from the video.

The processor 2100 may generate summary information about each of the determined summary frames and store the summary frames and the summary information in the memory 2400. The processor 2100 may search for a video that is similar to the input video, by using the summary frames and the summary information stored in the memory 2400, may generate a master summary, and may display a video from a reproduction location desired by the user when the video is reproduced.

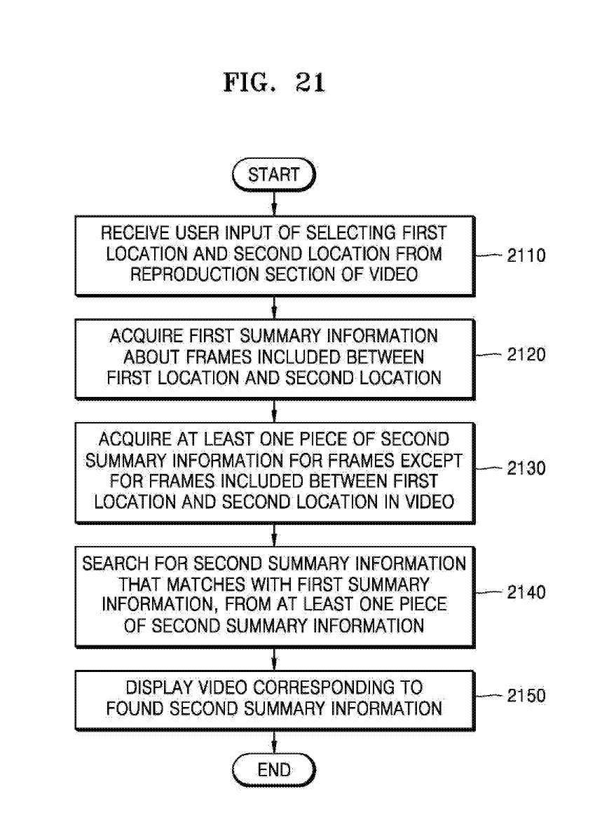

FIG. 21 is a flowchart of a method in which an electronic device displays a video, according to an exemplary embodiment. Referring to FIG. 21, the electronic device may search for a similar video within a single video and may provide a found similar video to the user.

In operation 2110, the electronic device receives a user input of selecting a first location and a second location from a reproduction section of the video.

In operation 2120, the electronic device acquires first summary information about frames included between the first location and the second location. The first summary information may be information that represents the frames included between the first location and the second location. Alternatively, the first summary information may be information about each of the frames included between the first location and the second location.

In operation 2130, the electronic device acquires at least one piece of second summary information for frames except for the frames included between the first location and the second location in the video. The electronic device acquires second summary information for a video included in a section, except for a section selected by the user, from the entire section of a single video. The electronic device may split the video included in the section, except for the section selected by the user, into a plurality of sections, and may acquire second summary information for frames included in each section.

The first summary information and the second summary information may include a feature, a shape, an arrangement, a motion, and the like of an object included in the video.

In operation 2140, the electronic device may search for second summary information that matches with the first summary information, from the at least one piece of second summary information. The electronic device searches for second summary information of which is the most identical with the first summary information in terms of the feature, the shape, the arrangement, the motion, and the like of the object.

The electronic device may determine a summary frame of a video corresponding to found second summary information. The electronic device may determine a summary frame from among the frames included in the video corresponding to the found second summary information.

In operation 2150, the electronic device may display the video corresponding to the found second summary information. The electronic device may display a first frame of the video corresponding to the found second summary information on the entire screen, or may display the first frame on a partial area of the screen.

The electronic device may also display a summary frame of the video corresponding to the found second summary information. When the user selects the summary frame, the electronic device reproduces a video corresponding to the selected summary frame. The electronic device may reproduce a video from the summary frame or may reproduce a video from the first frame.

When at least two videos corresponding to second summary information are found, the electronic device may display the at least two videos in a chronological sequence. The electronic device may display first frames of the at least two videos. The electronic device may also display summary frames of the at least two videos.

The exemplary embodiments may also be embodied as a computer readable storage medium including instruction codes executable by a computer such as a program module executed by the computer. A computer readable storage medium may be any usable medium which can be accessed by the computer and includes any type of a volatile/non-volatile and/or removable/non-removable medium. Further, the computer readable storage medium may include any type of a computer storage and communication medium. The computer readable storage medium includes any type of a volatile/non-volatile and/or removable/non-removable medium, embodied by a certain method or technology for storing information such as computer readable instruction code, a data structure, a program module or other data. The communication medium may include the computer readable instruction code, the data structure, the program module, or other data of a modulated data signal such as a carrier wave, or other transmission mechanism, and includes any information transmission medium.

Examples of the computer readable storage medium include a read-only memory (ROM), a random access memory (RAM), a compact-disc ROM (CD-ROM), a magnetic tape, a floppy disk, an optical data storage device, etc. In addition, the computer readable storage media may be distributed into the computer system that is connected through the networks to store and implement the computer readable codes in a distributed computing mechanism.

At least one of the components, elements, modules or units represented by a block as illustrated in the drawings may be embodied as various numbers of hardware, software and/or firmware structures that execute respective functions described above, according to an exemplary embodiment. For example, at least one of these components, elements or units may use a direct circuit structure, such as a memory, a processor, a logic circuit, a look-up table, etc. that may execute the respective functions through controls of one or more microprocessors or other control apparatuses. Also, at least one of these components, elements or units may be specifically embodied by a module, a program, or a part of code, which contains one or more executable instructions for performing specified logic functions, and executed by one or more microprocessors or other control apparatuses. Also, at least one of these components, elements or units may further include or implemented by a processor such as a central processing unit (CPU) that performs the respective functions, a microprocessor, or the like. Two or more of these components, elements or units may be combined into one single component, element or unit which performs all operations or functions of the combined two or more components, elements of units. Also, at least part of functions of at least one of these components, elements or units may be performed by another of these components, element or units. Further, although a bus is not illustrated in the above block diagrams, communication between the components, elements or units may be performed through the bus. Functional aspects of the above exemplary embodiments may be implemented in algorithms that execute on one or more processors. Furthermore, the components, elements or units represented by a block or processing steps may employ any number of related art techniques for electronics configuration, signal processing and/or control, data processing and the like.

The “unit” or “module” used herein may be a hardware component such as a processor or a circuit, and/or a software component that is executed by a hardware component such as a processor.

The respective elements described in an integrated form may be dividedly used, and the divided elements may be used in a state of being combined.

The exemplary embodiments should be considered in descriptive sense only and not for purposes of limitation. Descriptions of features or aspects within each embodiment should typically be considered as available for other similar features or aspects in other embodiments.

Although a few exemplary embodiments have been shown and described, it would be appreciated by those skilled in the art that changes may be made in the exemplary embodiments without departing from the principles and spirit of the disclosure, the scope of which is defined in the claims and their equivalents.

What is claimed is:

1. A method of providing a summary of a video in an electronic device, the method comprising:
determining first summary frames from among a plurality of frames of the video, based on a preset criterion;
generating a plurality of pieces of first summary information corresponding to the first summary frames; and
displaying at least one of the first summary frames and the plurality of pieces of first summary information, together with at least one frame of the video.

2. The method of claim 1, further comprising:
obtaining key frames located at preset time intervals of the video; and
determining the first summary frames based on a variation in a respective key frame.

3. The method of claim 1, wherein the first summary frames are displayed together with the at least one frame of the video, and
wherein the method further comprises:
receiving a user input to select a first summary frame from among the first summary frames; and
reproducing the video corresponding to a location of the selected first summary frame.

4. The method of claim 1, further comprising:
receiving a user input to select a first location and a second location of the video;
extracting a portion of the first summary frames included between the first location and the second location from the first summary frames;
extracting at least one first summary information corresponding to the extracted portion of the first summary frames;
obtaining a plurality of pieces of second summary information from a plurality of videos stored in the electronic device;
searching for at least one second summary information that matches with the at least one first summary information, from the plurality of pieces of second summary information; and
displaying at least one summary frame, of the plurality of videos, corresponding to the searched at least one second summary information.

5. The method of claim 1, wherein the first summary frames are displayed together with the at least one frame of the video, and
wherein the method further comprises:
receiving a user input to select a partial area of at least one of the first summary frames;
obtaining at least one first summary information corresponding to the selected partial area;
obtaining a plurality of pieces of second summary information from a plurality of videos stored in the electronic device;
searching for at least one second summary information that matches with the at least one first summary information, from the plurality of pieces of second summary information; and
displaying at least one summary frame, of the plurality of videos, corresponding to the searched at least one second summary information.

6. The method of claim 1, further comprising:
extracting summary videos of the video by using the first summary frames; and
generating a master summary based on the summary videos.

7. The method of claim 1, further comprising:
further displaying a plurality of second summary frames that are stored in the electronic device;
receiving a user input to select a second summary frame; and
reproducing the video corresponding to a location of the selected second summary frame.

8. The method of claim 1, further comprising in response to determining that a storage space of the electronic device is less than or equal to a preset threshold value, storing only the first summary frames and the plurality of pieces of first summary information, from among data included in the video, in the electronic device.

9. An electronic device comprising:
a display; and
a processor configured to:
determine first summary frames from among a plurality of frames of the video, based on a preset criterion,
generate a plurality of pieces of first summary information corresponding to the first summary frames, and
control the display to display at least one of the first summary frames and the plurality of pieces, together with at least one frame of the video.

10. The electronic device of claim 9, wherein the processor is further configured to obtain key frames located at preset time intervals of the video, and determine the first summary frames based on a variation in a respective key frame.

11. The electronic device of claim 9, wherein the processor is further configured to control the display to display the first summary frames, together with the at least one frame of the video,
wherein the electronic device further comprises an input unit configured to receive a user input to select a first summary frame from among the displayed first summary frames, and
wherein the processor is further configured to reproduce the video corresponding to a location of the selected first summary frame.

12. The electronic device of claim 9, further comprising an input unit configured to receive a user input to select a first location and a second location of the video,
wherein the processor is further configured to extract a portion of the first summary frames included between the first location and the second location from the first summary frames, extract at least one first summary information corresponding to the extracted portion of the first summary frames, obtain plurality of pieces of second summary information from a plurality of videos stored in the electronic device, search for at least one second summary information that matches with the at least one first summary information, from the plurality of pieces of second summary information, and display at least one summary frame of the plurality of videos corresponding to the searched at least one second summary information.

13. The electronic device of claim 12, wherein the processor is further configured to obtain locations of the first summary frames, obtain summary videos corresponding to the locations of the first summary frames, and generate a master summary based on the summary videos.

14. The electronic device of claim 9, further comprising a memory configured to store the first summary frames and the plurality of pieces of first summary information,
wherein the processor is further configured to determine whether a storage space of the memory is less than or equal to a preset threshold value, and
wherein the memory is further configured to, when it is determined that the storage space is less than or equal to the preset threshold value, store only the first summary frames and the plurality of pieces of first summary information from among data included in the video.

15. An electronic device comprising:
a memory;
a processor;
an input unit configured to receive a user input to select a first location and a second location of a video; and
a display,
wherein the processor is configured to obtain first summary information corresponding to at least one of first frames included between the first location and the second location, obtain at least one piece of second summary information corresponding to second frames of the video, the second frames excluding the first frames, and search for second summary information that matches with the first summary information from among the at least one piece of second summary information, and
wherein the display is configured to display a partial video, of the video, corresponding to the searched second summary information.

16. The electronic device of claim 15, wherein the processor is further configured to determine a summary frame of the video based on the searched second summary information, and
wherein the display is further configured to display the summary frame.

17. The electronic device of claim 15, wherein the processor is further configured to, when at least two partial videos correspond to the searched second summary information, control the display to display the at least two partial videos.

18. A method of displaying a video on an electronic device, the method comprising:
receiving a user input to select a first location and a second location of the video;
obtaining first summary information corresponding to at least one of first frames included between the first location and the second location;
obtaining at least one piece of second summary information corresponding to second frames of the video, the second frames excluding the first frames;
searching for second summary information that matches with the first summary information, from the at least one piece of second summary information; and
displaying a partial video, of the video, corresponding to the searched second summary information.

19. The method of claim 18, further comprising determining a summary frame of the video based on the searched second summary information,
wherein the displaying comprises displaying the summary frame.

20. The method of claim 18, wherein the displaying comprises, when at least two partial videos correspond to the searched second summary information, displaying the at least two partial videos.
